(19) United States
(12) Patent Application Publication
(10) Pub. No.: US 2013/0146219 A1
(43) Pub. Date: Jun. 13, 2013

(54) Cosmetic Restoration of Stainless Steel Surfaces

(71) Applicant: Timothy M. Sullivan, Eastvale, CA (US)

(72) Inventor: Timothy M. Sullivan, Eastvale, CA (US)

(21) Appl. No.: 13/709,246

(22) Filed: Dec. 10, 2012

Related U.S. Application Data
(60) Provisional application No. 61/568,515, filed on Dec. 8, 2011.

(51) Int. Cl. B32B 38/10; C09J 7/02

(52) U.S. Cl. CPC B32B 38/10; C09J 7/02
USPC 156/247; 428/354

(57) ABSTRACT

A method for cosmetically restoring a stainless steel surface. The stainless steel surface is cleaned and a multi-layered material is applied over the stainless steel surface. The multi-layer material includes a first layer having the appearance of the stainless steel surface, and at least one clear protective layer over the first layer. The first layer has a peel strength of two to four times the peel strength of the clear protective layer and as a result, the clear protective layer is peelable and replaceable while leaving the first layer in place. In one embodiment, the first layer has a peel strength of at least two times the peel strength of the clear protective layer, for example, the first layer may have a peel strength of eleven to fifteen pounds per square inch and the clear protective layer may have a peel strength of four to five pounds per square inch.

### CROSS-REFERENCE TO RELATED APPLICATIONS

The present application claims the priority of U.S. Provisional Patent Application Ser. No. 61/568,515 filed 08 Dec. 2011, which application is incorporated in its entirety herein by reference.

### BACKGROUND OF THE INVENTION

The present invention relates to restoration of surfaces and in particular to restoring and maintaining the appearance of stainless steel surfaces.

Vandalism and tagging in particular has long been a problem both due to the damage to property and to violence associated with gang related tagging. Such vandalism is frequent in commercial restrooms due to the fact that there are no cameras in public restrooms. Many fixtures in these restrooms are made of stainless steel including: restroom stalls and doors; toilet paper dispensers; paper toil dispensers; toilet seat cover dispensers; and many other items in commercial restrooms. In commercial buildings stainless steel is vandalized such as elevators, elevator doors, and drinking fountains. Rail and bus vehicles have stainless steel walls and doors that are often vandalized as well. Stainless steel is often used on these exposed areas due to it's resistance to corrosion, but scratched stainless steel may be difficult to return to it's original appearance due to it's hardness and expensive to replace or repair using known methods.

### BRIEF SUMMARY OF THE INVENTION

The present invention addresses the above and other needs by providing a method for cosmetically restoring a stainless steel surface. The stainless steel surface is cleaned and a multi-layered material is applied over the stainless steel surface. The multi-layer material includes a first layer having the appearance of the stainless steel surface, and at least one clear protective layer over the first layer. The first layer has a peel strength of two to four times the peel strength of the clear protective layer and as a result, the clear protective layer is peelable and replaceable while leaving the first layer in place. In one embodiment, the first layer has a peel strength of at least two times the peel strength of the clear protective layer, for example, the first layer may have a peel strength of eleven to fifteen pounds per square inch and the clear protective layer may have a peel strength of four to five pounds per square inch.

In accordance with one aspect of the invention, there is provided a method for cosmetic restoration of stainless steel. The method includes the steps of: cleaning a damaged stainless steel surface; obtaining a laminated multi-layered film having a first (or bottom) layer having a top surface with the appearance of stainless steel and a bottom surface having an adhesive, and at least one original clear protective layer over the first layer, the clear protective layer peelable from the first layer; applying the multi-layered film to the stainless steel surface with the adhesive bearing bottom surface against the stainless steel surface; waiting until the original clear protective layer has been damaged; peeling the damaged clear protective layer from the first layer; and applying at least one secondary clear protective layer over the first layer.

In accordance with another aspect of the invention, there is provided a material for cosmetic restoration of stainless steel surfaces. The material includes a first layer having a top surface with the appearance of stainless steel and a bottom surface having an adhesive and at least one original clear protective layer over the top surface of the first layer, the original clear protective layer peelable from the first layer. Importantly, the clear protective layer is attached to the first layer at a production facility to provide a two layer material easily applied at a work site. Separate application of two or more layers at a work site requires more time and creates greater opportunity for misalignment of the layers. Both layers are cut in a single step at a work site and applied in a single step. Such single cutting and applying provides a simple application reducing time at the work site.

In accordance with still another aspect of the invention, there is provided a material for cosmetic restoration of stainless steel surfaces. The material includes a bottom layer with the appearance of the stainless steel surface and a peel strength of 11 to 15 pounds per square inch, and a removable clear protective layer over the bottom layer, the clear protective layer having a peel strength of four to five pounds per square inch. The greater peel strength of the bottom layer allows the clear protective layer to be removed and replaced without damaging the bottom layer.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A shows a scratched stainless steel surface.

FIG. 1B shows a partially installed two layer cosmetic restoration material having a clear protective layer according to the present invention on the scratched stainless steel surface.

FIG. 1C shows a restored stainless steel surface according to the present invention.

FIG. 2A shows the restored stainless steel surface after damage to the clear protective layer.

FIG. 2B shows a partially peeled clear protective layer.

FIG. 2A shows the restored stainless steel surface after a new clear protective layer has been installed.

FIG. 3 is a method according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

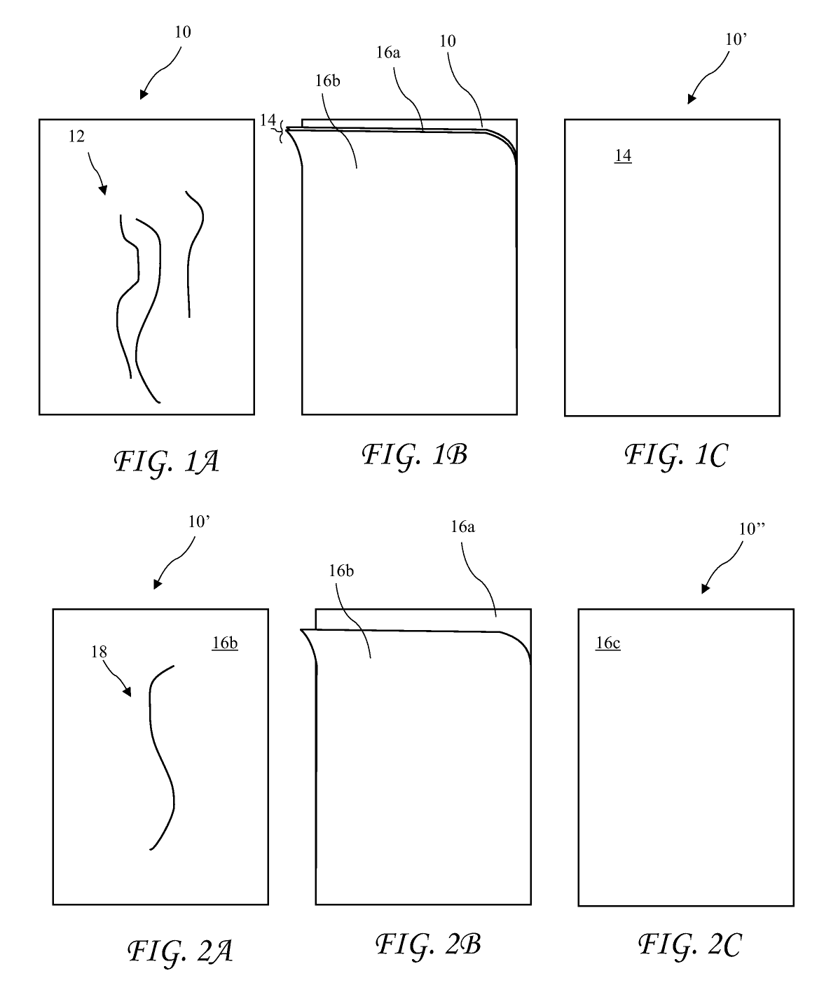

A scratched stainless steel surface 10 having a scratched stainless steel surface 12 is shown in FIG. 1A, a partially installed two layer cosmetic restoration material 14, having a first layer 16a providing the appearance of stainless steel and clear protective layer 16b, according to the present invention is shown on the scratched stainless steel surface 12 in FIG. 1B, and a restored stainless steel surface 10′ is shown in FIG. 1C. The first layer 16a includes adhesive on a bottom surface for attaching to the stainless steel 10. The clear protective layer 16b is attached to the first layer 16a during production of the cosmetic restoration material 14.

The restored stainless steel surface 10′, after damage to the clear protective layer 16b, is shown in FIG. 2A, a partially peeled clear protective layer 16b is shown in FIG. 2B, and the restored stainless steel surface 10″ after a new clear protective layer 16c has been installed is shown in FIG. 2C. The clear protective layer 16b is a peelable layer allowing peeling from the first layer 16a and replacement, after damage to the clear layer.

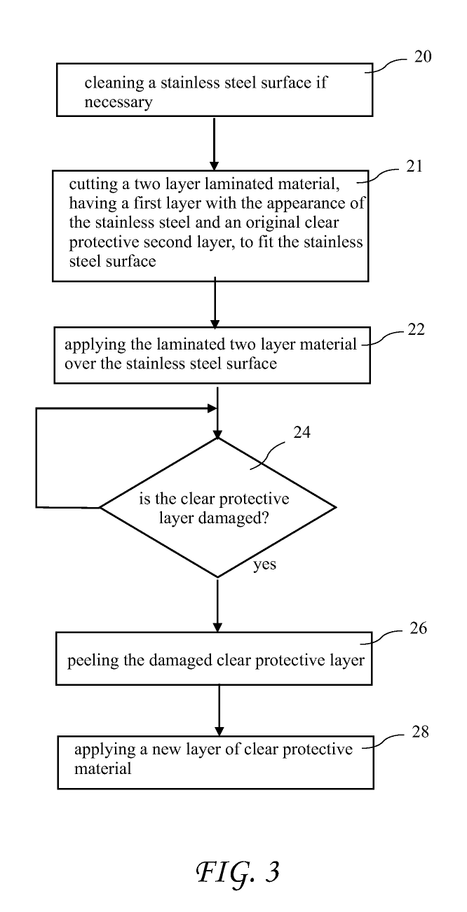

A method according to the present invention is shown in FIG. 3. The method includes the steps of cleaning the stainless steel surface if necessary at step 20, cutting a two layer laminated material, having a first layer with the appearance of the stainless steel and an original clear protective second layer, to fit the stainless steel surface, at step 21, apply the laminated two layer material over the stainless steel surface, at step 22, observing if the clear protective second layer has been damaged at step 24, and if the clear protective second layer has been damaged, peeling the damaged clear protective second layer at step 26, and applying a new layer of clear protective material at step 28.

The first layer is preferably a polyester or a metalized film between one and three mils thick and having a top surface with the appearance of stainless steel and a self adhesive with peel off overlay on a bottom surface. The second layer is preferably a graffiti protective film made of polyester or Mylar having a thickness preferably between four and six mils that can withstand scratching by vandals. The first layer preferably has a peel strength of at least twice the peel strength of the second layer, and more preferably a peel strength of at least three times the peel strength of the second layer. An example of peel strength of a suitable first layer is 11 to 15 pounds per square inch and an example of peel strength of a suitable second layer is four to five pounds per square inch.

An example of a polyester material suitable for the first layer 16a is 047 brushed chrome made by Universal Products 521 Industrial Products Goddard, KS 67052. An example of a metalized film material suitable for the first layer 16a is made by Creative Film Corp. 700 Vassar Ave Lakewood Industrial Pk N.J. 08701. An example of material suitable for the second layer 16b and 16c is LCL 600 made by Madico, Inc. 64 Industrial Parkway Woburn, Mass. 01801.

While the invention herein disclosed has been described by means of specific embodiments and applications thereof, numerous modifications and variations could be made thereto by those skilled in the art without departing from the scope of the invention set forth in the claims.

I claim:

1. A method for cosmetic restoration of stainless steel, the method comprising:
cleaning a damaged stainless steel surface;
obtaining a multi-layered film comprising:
a first layer having a top surface with an appearance of stainless steel and a bottom surface having an adhesive; and
at least one original clear protective layer over the first layer, the original clear protective layer peelable from the first layer;
cutting the multi-layered film to fit the stainless steel surface;
applying the multi-layered film to the stainless steel surface with the adhesive bearing bottom surface of the first layer against the stainless steel surface;
waiting until the original clear protective layer has been damaged;
peeling the damaged original clear protective layer from the first layer; and
applying at least one secondary clear protective layer over the first layer.

2. The method of claim 1, wherein obtaining a multi-layered film comprises obtaining a multi-layered film having the first layer having a peel strength of at least two times the peel strength of the original clear protective layer.

3. The method of claim 2, wherein obtaining a multi-layered film comprises obtaining a multi-layered film having the first layer having a peel strength of between two and four times the peel strength of the original clear protective layer.

4. The method of claim 1, wherein obtaining a multi-layered film comprises obtaining a multi-layered film having the first layer having a peel strength of 11 to 15 pounds per square inch and the original clear protective layer has a peel strength of four to five pounds per square inch.

5. The method of claim 1, wherein obtaining a multi-layered film comprises obtaining a multi-layered film laminated at a production facility.

6. A method for cosmetic restoration of stainless steel, the method comprising:
cleaning a damaged stainless steel surface;
obtaining a multi-layered film laminated at a production facility and comprising:
a first layer having a top surface with an appearance of stainless steel and a bottom surface having an adhesive having a peel strength of between 11 and 15 pounds per square inch; and
at least one original clear protective layer over the first layer, the original clear protective layer having a peel strength of between four and five pounds per square inch;
cutting the multi-layered film to fit over the stainless steel surface;
applying the multi-layered film to the stainless steel surface with the adhesive bearing bottom surface against the stainless steel surface;
waiting until the original clear protective layer has been damaged;
peeling the damaged original clear protective layer from the first layer; and
applying at least one secondary clear protective layer over the first layer.

7. A material for cosmetic restoration of stainless steel surfaces, the material comprising:
a first layer having a top surface with the appearance of stainless steel and a bottom surface having an adhesive; and
at least one clear protective layer laminated over the top surface of the first layer, the first layer having at least twice the peel strength of the clear layer.

8. The material of claim 7, wherein the first layer has between two and four times the peel strength of the original clear protective layer.

9. The material of claim 7, wherein the first layer has a peel strength of 11 to 15 pounds per square inch and the original clear protective layer has a peel strength of four to five pounds per square inch.
